(19) United States
(12) Patent Application Publication
(10) Pub. No.: US 2013/0329042 A1
(43) Pub. Date: Dec. 12, 2013

(54) IMAGE PICK-UP DEVICE, IMAGE PICK-UP SYSTEM EQUIPPED WITH IMAGE PICK-UP DEVICE, AND IMAGE PICK-UP METHOD

(71) Applicants: Akiko Murata, Osaka (JP); Norihiro Imamura, Osaka (JP)

(72) Inventors: Akiko Murata, Osaka (JP); Norihiro Imamura, Osaka (JP)

(73) Assignee: PANASONIC CORPORATION, Osaka (JP)

(21) Appl. No.: 14/001,978

(22) PCT Filed: Feb. 3, 2012
(86) PCT No.: PCT/JP2012/000728

§ 371 Date: Aug. 28, 2013

(30) Foreign Application Priority Data
Apr. 27, 2011 (JP) 2011-099165

(51) Int. Cl. H04N 7/18

(52) U.S. Cl. CPC H04N 7/18
USPC 348/140; 348/360; 348/222.1

(57) ABSTRACT

An image pickup apparatus includes: a lens optical system including six regions having such optical characteristics that focal characteristics are made different from one another; an image pickup device having a plurality of pixels on which light beams having passed through the lens optical system are incident; and an arrayed optical device for making light beams having passed through the six regions incident respectively on different pixels on the image pickup device.

### TECHNICAL FIELD

The present invention relates to an image pickup apparatus such as a camera, and an image pickup method using the image pickup apparatus.

### BACKGROUND ART

In recent years, distance measurement apparatuses for measuring the distance to an object (an object to which the distance is measured) based on the parallax between a plurality of image pickup optical systems have been used for the following distance measurement for automobiles, auto focus systems for cameras, and three-dimensional shape measurement systems.

In such a distance measurement apparatus, a pair of image pickup optical systems arranged in the left-right direction or in the vertical direction form images on the respective image pickup areas, and the distance to the object is detected through triangulation using the parallax between those images.

The DFD (Depth From Defocus) method is known as a scheme for measuring the distance from a single image pickup optical system to an object. While the DFD method is an approach in which the distance is calculated by analyzing the amount of blur of the obtained image, it is not possible with a single image to determine whether it is a pattern of the object itself or a blur caused by the object distance, and therefore methods for estimating the distance from a plurality of images have been used (Patent Document 1, Non-Patent Document 1).

### CITATION LIST

### Patent Literature

[Patent Document 1] Japanese Patent No. 3110095
[Patent Document 2] Japanese Laid-Open Patent Publication No. 2010-39162

### Non-Patent Literature

[Non-Patent Document 1] Xue Tu, Youn-sik Kang and Murali Subbarao, “Two- and Three-Dimensional Methods for Inspection and Metrology V.”, Edited by Huang, Peisen S. Proceedings of the SPIE, Volume 6762, pp. 676203 (2007).

### SUMMARY OF INVENTION

### Technical Problem

Configurations using a plurality of image pickup optical systems increase the size and cost of the image pickup apparatus. Moreover, it is necessary to provide a plurality of image pickup optical systems of uniform characteristics and to ensure that optical axes of a plurality of image pickup optical systems are parallel to one another with a high precision, thus making the manufacture more difficult; and since a calibration process for determining camera parameters is needed, thereby requiring a large number of steps.

With such DFD methods as disclosed in Patent Document 1 and Non-Patent Document 1, it is possible to calculate the distance to an object with a single image pickup optical system. With the methods of Patent Document 1 and Non-Patent Document 1, however, it is necessary to obtain a plurality of images in a time division manner while varying the distance to an object in focus (the focal length). Applying such an approach to a movie, misalignment occurs between images due to the time lag in the image-capturing operation, thereby lowering the distance measurement precision.

Patent Document 1 discloses an image pickup apparatus in which the optical path is divided by a prism, and an image is captured by two image pickup surfaces of varied back focuses, thereby making it possible to measure the distance to an object in a single iteration of image capture. However, such a method requires two image pickup surfaces, thereby increasing the sizes of the image pickup apparatus and significantly increasing the cost.

The present invention has been made in order to solve such problems as described above, and a primary object thereof is to provide an image pickup apparatus and an image pickup method capable of obtaining brightness information with which it is possible to calculate the object distance using a single image pickup optical system.

### Solution to Problem

An image pickup apparatus of the present invention includes: a lens optical system having a plurality of regions including six regions having such optical characteristics that focal characteristics are made different from one another; an image pickup device having a plurality of pixels on which light beams having passed through the lens optical system are incident; and an arrayed optical device arranged between the lens optical system and the image pickup device for making light beams having passed through the six regions incident respectively on different pixels on the image pickup device.

An image pickup system of the present invention includes: an image pickup apparatus of the present invention; and a signal processing device for calculating a distance to an object using brightness information of a plurality of pixels obtained respectively from six different pixels on which light beams having passed through six regions of the image pickup apparatus are incident.

An image pickup method of the present invention uses image pickup apparatus including: a lens optical system having a plurality of regions including six regions having such optical characteristics that focal characteristics are made different from one another; an image pickup device having a plurality of pixels on which light beams having passed through the lens optical system are incident; and an arrayed optical device arranged between the lens optical system and the image pickup device, the method including: making light beams having passed through the six regions incident respectively on different pixels on the image pickup device by means of the arrayed optical device; and calculating a distance to an object using brightness information of a plurality of pixels obtained respectively from six different pixels on which light beams having passed through six regions are incident.

Another image pickup apparatus of the present invention includes: a lens optical system having a plurality of regions including three regions having such optical characteristics that focal characteristics are made different from one another; an image pickup device having a plurality of pixels on which light beams having passed through the lens optical system are incident and of which center points of the pixels are located at apices of a regular hexagon; and an arrayed optical device arranged between the lens optical system and the image pickup device for making light beams having passed through the three regions incident on different pixels on the image pickup device.

Still another image pickup apparatus of the present invention includes: a lens optical system having a plurality of regions including four regions having such optical characteristics that focal characteristics are made different from one another; an image pickup device including a plurality of pixels on which light beams having passed through the lens optical system are incident and of which positions of center points in a row direction are shifted from one row to another by half a pixel arrangement pitch; and an arrayed optical device arranged between the lens optical system and the image pickup device for making light beams having passed through the four regions incident on different pixels on the image pickup device.

### Advantageous Effects of Invention

According to the present invention, it is possible to obtain brightness information with which the object distance can be calculated through image capture using a single image pickup system. In the present invention, it is not necessary to make uniform the characteristics or the positions of a plurality of image pickup optical systems as with an image pickup apparatus using a plurality of image pickup optical systems, thus allowing for a reduction in the number of steps and facilitating the manufacturing process. Moreover, where a movie is captured using an image pickup apparatus of the present invention, it is possible to measure the accurate distance to an object even if the position of the object varies over the passage of time.

### BRIEF DESCRIPTION OF DRAWINGS

FIG. 1 A schematic diagram showing Embodiment 1 of an image pickup apparatus A according to the present invention.

FIG. 2 A front view of an optical device L1 according to Embodiment 1 of the present invention, as viewed from the object side.

FIG. 3 A perspective view of an arrayed optical device K according to Embodiment 1 of the present invention.

FIG. 4 (a) is a diagram showing, on an enlarged scale, the arrayed optical device K and an image pickup device N shown in FIG. 1, and (b) is a diagram showing the positional relationship between the arrayed optical device K and pixels on the image pickup device N.

FIG. 5 A cross-sectional view showing the image pickup apparatus A according to the present invention.

FIG. 6 A graph showing the relationship between the object distance and the degree of sharpness (the sharpness of the image) according to Embodiment 1 of the present invention.

FIG. 7 (a) to (c) are diagrams each showing the brightness distribution of an image block having a size of 16×16, and (d) to (f) are diagrams showing the frequency spectra obtained by performing a two-dimensional Fourier transform on the image blocks shown in (a) to (c), respectively.

FIG. 8 A front view of the optical device L1 according to Embodiment 1 of the present invention, as viewed from the object side.

FIG. 9 A diagram showing the positional relationship between the arrayed optical device K and pixels on the image pickup device N according to Embodiment 1 of the present invention.

FIG. 10 A front view of the optical device L1 according to Embodiment 1 of the present invention, as viewed, from the object side.

FIG. 11 A diagram showing the positional relationship between the arrayed optical device K and pixels on the image pickup device N according to Embodiment 1 of the present invention.

FIG. 12 A perspective view of the arrayed optical device K according to Embodiment 1 of the present invention.

FIG. 13 A diagram showing the positional relationship between the arrayed optical device K and pixels on the image pickup device N according to Embodiment 1 of the present invention.

FIG. 14 A schematic diagram showing Embodiment 2 of the image pickup apparatus A according to the present invention.

FIG. 15 A front view of the optical device L1 according to Embodiment 2 of the present invention, as viewed from the object side.

FIG. 16 (a) is a diagram showing, on an enlarged scale, the arrayed optical device K and the image pickup device N shown in FIG. 14, and (b) is a diagram showing the positional relationship between the arrayed optical device K and pixels on the image pickup device N.

FIG. 17 A graph showing the relationship between the object distance and the degree of sharpness (the sharpness of the image) according to Embodiment 2 of the present invention.

FIG. 18 A front view of the optical device L1 according to Embodiment 2 of the present invention, as viewed from the object side.

FIG. 19 A diagram showing the positional relationship between the arrayed optical device K and pixels on the image pickup device N according to Embodiment 2 of the present invention.

FIG. 20 (a1) is a perspective view showing a microlens array having a rotationally asymmetric shape with respect to the optical axis. (a2) is a diagram showing the contour lines of the microlens array shown in (a1). (a3) is a diagram showing the results of a light beam tracking simulation in a case where the microlens shown in (a1) and (a2) is applied to the arrayed optical device of the present invention. (b1) is a perspective view showing a microlens array having a rotationally symmetric shape with respect to the optical axis. (b2) is a diagram showing the contour lines of the microlens array shown in (b1). (b3) is a diagram showing the results of a light beam tracking simulation in a case where the microlens shown in (b1) and (b2) is applied to the arrayed optical device according to an embodiment of the present invention.

### DESCRIPTION OF EMBODIMENTS

Embodiments of the image pickup apparatus of the present invention will now be described with reference to the drawings.

### Embodiment 1

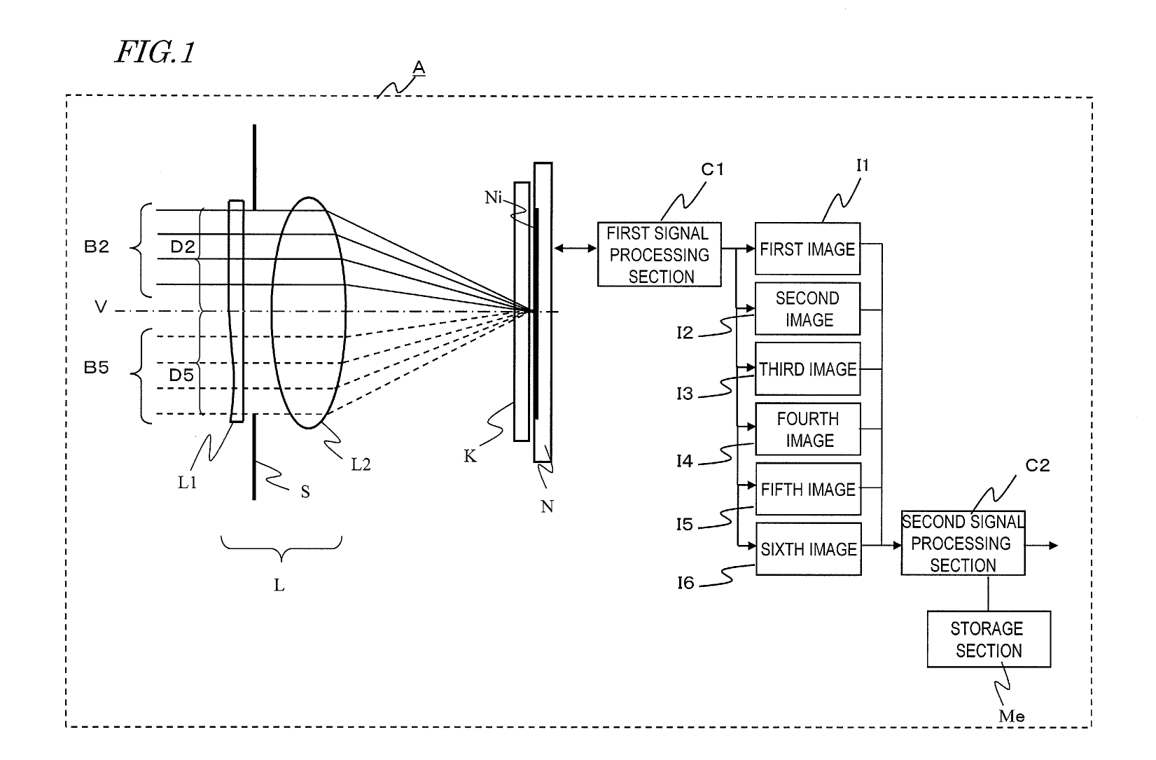

FIG. 1 is a schematic diagram showing an image pickup apparatus A of Embodiment 1. The image pickup apparatus A of the present embodiment includes a lens optical system L whose optical axis is V, an arrayed optical device K arranged in the vicinity of the focal point of the lens optical system L, an image pickup device N, a first signal processing section C1, a second signal processing section C2, and a storage section Me.

The lens optical system L has six optical regions D1, D2, D3, D4, D5 and D6 (FIG. 1 shows a cross section passing through D2 and D5) having such optical characteristics that focal characteristics are made different from one another, and is composed of an optical device L1 on which light beams B1, B2, B3, B4, B5 and B6 (FIG. 1 shows a cross section passing through B2 and B5) from an object (not shown) are incident, a stop S on which light having passed through the optical device L1 is incident, and a lens L2 on which light having passed through the stop S is incident. The optical device L1 is preferably arranged in the vicinity of the stop S.

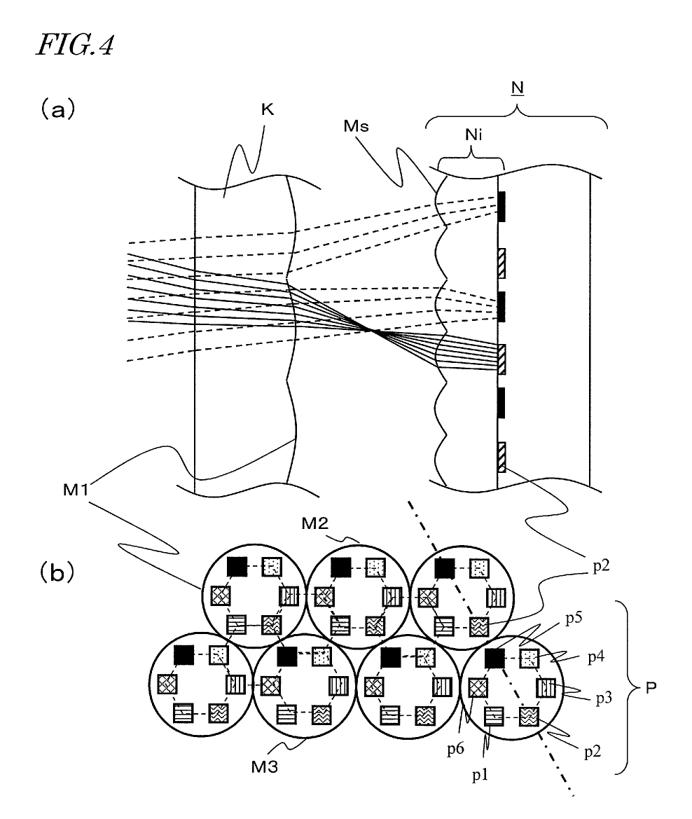

In the present embodiment, light beams having passed through the six optical regions D1, D2, D3, D4, D5 and D6 pass through the lens L2 and then are incident on the arrayed optical device K. The arrayed optical device K causes the light beams having passed through the six optical regions D1, D2, D3, D4, D5 and D6 to be incident on six pixel groups P1, P2, P3, P4, P5 and P6 of the image pickup device N, respectively. A plurality of pixels belong to each of the six pixel groups P1, P2, P3, P4, P5 and P6. For example, in FIG. 4(b), pixels p1, p2, p3, p4, p5, p6 are pixels belonging to the pixel groups P1, P2, P3, P4, P5, P6, respectively.

The first signal processing section C1 outputs images I1, I2, I3, I4, I5 and I6 obtained from the pixel groups P1, P2, P3, P4, P5 and P6, respectively. Since the optical characteristics of the six optical regions D1, D2, D3, D4, D5 and D6 are different from one another, the degrees of sharpness (values calculated by using the brightness) of the images I1, I2, I3, I4, I5 and I6 are different from one another depending on the object distance. The storage section Me stores the correlation between the degree of sharpness and the object distance for each of the light beams having passed through the optical regions D1, D2, D3, D4, D5 and D6. In the second signal processing section C2, it is possible to obtain the distance to the object based on the degrees of sharpness for the images I1, I2, I3, I4, I5 and I6 and the correlations.

FIG. 2 is a front view of the optical device L1 as viewed from the object side. The optical device L1 is divided into six portions, the optical regions D1, D2, D3, D4, D5 and D6, in a plane perpendicular to the optical axis V, with the optical axis V being the boundary center. In FIG. 2, the broken line s denotes the position of the stop S. The light beam B2 in FIG. 1 is a light beam passing through the optical region D2 on the optical device L1, and the light beam B5 is a light beam passing through the optical region D5 on the optical device L1. The light beams B1, B2, B3, B4, B5 and B6 pass through the optical device L1, the stop S, the lens L2 and the arrayed optical device K in this order to arrive at an image pickup surface Ni on the image pickup device N (shown in FIG. 4, etc.).

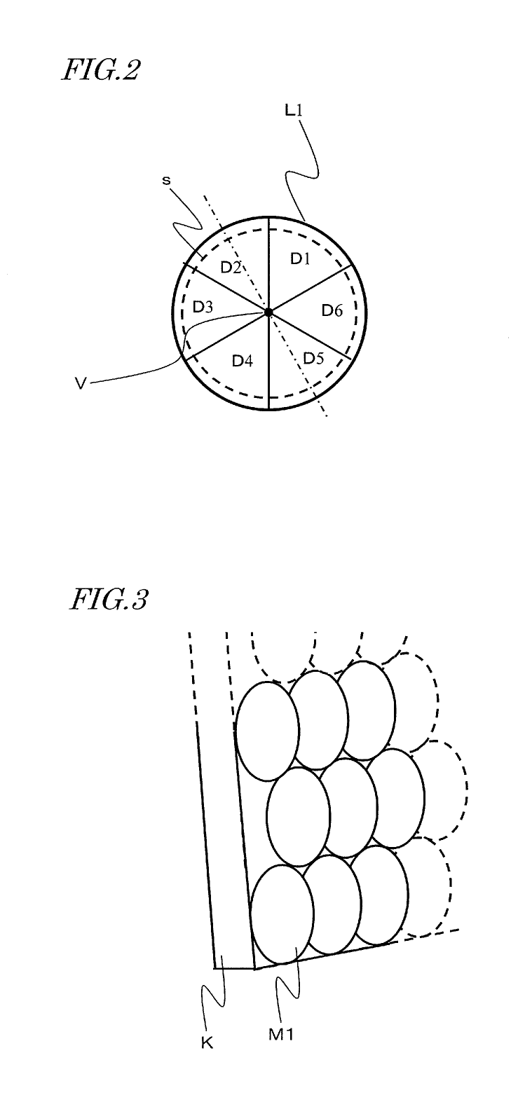

FIG. 3 is a perspective view of the arrayed optical device K. On one surface of the arrayed optical device K that is closer to the image pickup device N, optical elements M1 are arranged in a hexagonal close-packed pattern in a plane perpendicular to the optical axis V. The cross section (the longitudinal cross section) of each optical element M1 has a curved shape protruding toward the image pickup device N. Thus, the arrayed optical device K has a structure of a microlens array.

As shown in FIG. 1, the arrayed optical device K is arranged in the vicinity of the focal point of the lens optical system L, and is arranged at a position away from the image pickup surface Ni by a predetermined distance. In practice, while the optical characteristics of the optical device L1 influence the focal characteristics of the lens optical system L as a whole, the position at which the arrayed optical device K is arranged may be determined based on, for example, the focal point of the lens L2. Note that the “focal characteristics being different” as used in the present embodiment refers to difference in at least one of characteristics that contribute to light condensing in the optical system, and specifically to difference in the focal length, the distance to an object in focus, the distance range where the degree of sharpness is greater than or equal to a certain value, etc. By varying the optical characteristics by adjusting the radius of curvature of the surface, the aspherical coefficient or the refractive index between the optical regions D1, D2, D3, D4, D5 and D6, it is possible to vary focal characteristics for light beams having passed through the different regions.

FIG. 4(a) is a diagram showing, on an enlarged scale, the arrayed optical device K and the image pickup device N shown in FIG. 1, and FIG. 4(b) is a diagram showing the positional relationship between the arrayed optical device K and pixels on the image pickup device N. The arrayed optical device K is arranged so that the surface thereof on which the optical elements M1 are formed is facing the image pickup surface Ni. Pixels P having a geometric shape are arranged on the image pickup surface Ni so that the center point of each pixel P is at an apex of a regular hexagon. Specifically, honeycomb-array pixels described in Patent Document 2 may be used. A plurality of pixels P provided on the image pickup surface can each be classified as a pixel belonging to one of the pixel groups P1, P2, P3, P4, P5 and P6. The arrayed optical device K is arranged so that one optical element M1 thereof corresponds to six pixels p1, p2, p3, p4, p5 and p6 included in the pixel groups P1, P2, P3, P4, P5 and P6, respectively. The center points of the six pixels p1, p2, p3, p4, p5 and p6 included in the first to sixth pixel groups P1, P2, P3, P4, P5 and P6, respectively, are located at the apices of a regular hexagon. Microlenses Ms (the optical elements M1) are provided on the image pickup surface Ni so as to respectively cover the six pixels p1, p2, p3, p4, p5 and p6 included in the pixel groups P1, P2, P3, P4, P5 and P6, respectively.

Note that the optical elements M1 are preferably arranged in a hexagonal close-packed pattern so that pixels arranged to be at the apices of a regular hexagon can be covered efficiently.

The arrayed optical device is designed so that the majority of the light beams B1, B2, B3, B4, B5 and B6 having passed through the optical regions D1, D2, D3, D4, D5 and D6 on the optical device L1 arrives at the pixel groups P1, P2, P3, P4, P5 and P6 on the image pickup surface Ni, respectively. Specifically, this configuration can be realized by appropriately setting parameters, such as the refractive index of the arrayed optical device K, the distance from the image pickup surface Ni, and the radius of curvature of the surface of the optical element M1.

Now, the first signal processing section C1 shown in FIG. 1 outputs the first image I1 formed only by the pixel group P1. Similarly, the images I2 . . . I6 formed only by the pixel groups P2 . . . P6, respectively, are output. The second signal processing section C2 performs a distance measurement calculation using the brightness information represented by differences in brightness value between adjacent pixels (the degree of sharpness) in the images I1, I2, I3, I4, I5 and I6.

The images I1, I2, I3, I4, I5 and I6 are images obtained by the light beams B1, B2, B3, B4, B5 and B6 having passed through the optical regions D1, D2, D3, D4, D5 and D6 having such optical characteristics that focal characteristics are made different from one another. The second signal processing section C2 calculates the distance to the object by using the degree of sharpness (brightness information) of a plurality of images obtained for a plurality of pixel groups among the first to sixth pixel groups P1 to P6. In the present embodiment, using the images I1, I2, I3, I4, I5 and I6, it is possible to precisely obtain the distance to an object at a short distance, as compared with a method where the number of divisions of optical regions is smaller. That is, it is possible to precisely obtain the distance to the object through (e.g., a single iteration of) image capture using a single image pickup optical system (the lens optical system L).

The stop S is a region through which light beams of all field angles pass. Therefore, by inserting a plane having optical characteristics for controlling focal characteristics in the vicinity of the stop S, it is possible to similarly control focal characteristics of light beams of all field angles. That is, in the present embodiment, it is preferred that the optical device L1 is provided in the vicinity of the stop S. As the optical regions D1, D2, D3, D4, D5 and D6 having such optical characteristics that focal characteristics are made different from one another are arranged in the vicinity of the stop S, the light beams can be given focal characteristics according to the number of divisions of regions.

In FIG. 1, the optical device L1 is provided at a position such that light having passed through the optical device L1 is incident on the stop S directly (with no other optical members interposed therebetween). The optical device L1 may be provided closer to the image pickup device N than the stop S. In such a case, it is preferred that the optical device L1 is provided between the stop S and the lens L2 and light having passed through the stop S is incident on the optical device L1 directly (with no other optical members interposed therebetween). In the case of an image-side telecentric optical system, the angle of incidence of the light beam at the focal point of the optical system is uniquely determined based on the position of the light beam passing through the stop S and the field angle. The arrayed optical device K has the function of varying the outgoing direction based on the angle of incidence of the light beam. Therefore, it is possible to distribute light beams among pixels on the image pickup surface Ni so as to correspond to the optical regions D1, D2, D3, D4, D5 and D6 divided in the vicinity of the stop S.

Next, a specific method for obtaining the object distance will be described.

FIG. 5 is a cross-sectional view showing the image pickup apparatus A of Embodiment 1. In FIG. 5, like components to those of FIG. 1 are denoted by like reference numerals to those of FIG. 1. While the arrayed optical device K (shown in FIG. 1, etc.) is not shown in FIG. 5, the region H of FIG. 5 in practice includes the arrayed optical device K. The region H has a configuration shown in FIG. 4(a). Design data of such an optical system as shown in FIG. 5 is produced, and the point spread formed by the light beams B1, B2, B3, B4, B5 and B6 having passed through the optical regions D1, D2, D3, D4, D5 and D6 is obtained. Then, the six images obtained by 6-fold division are converted to a square-array image.

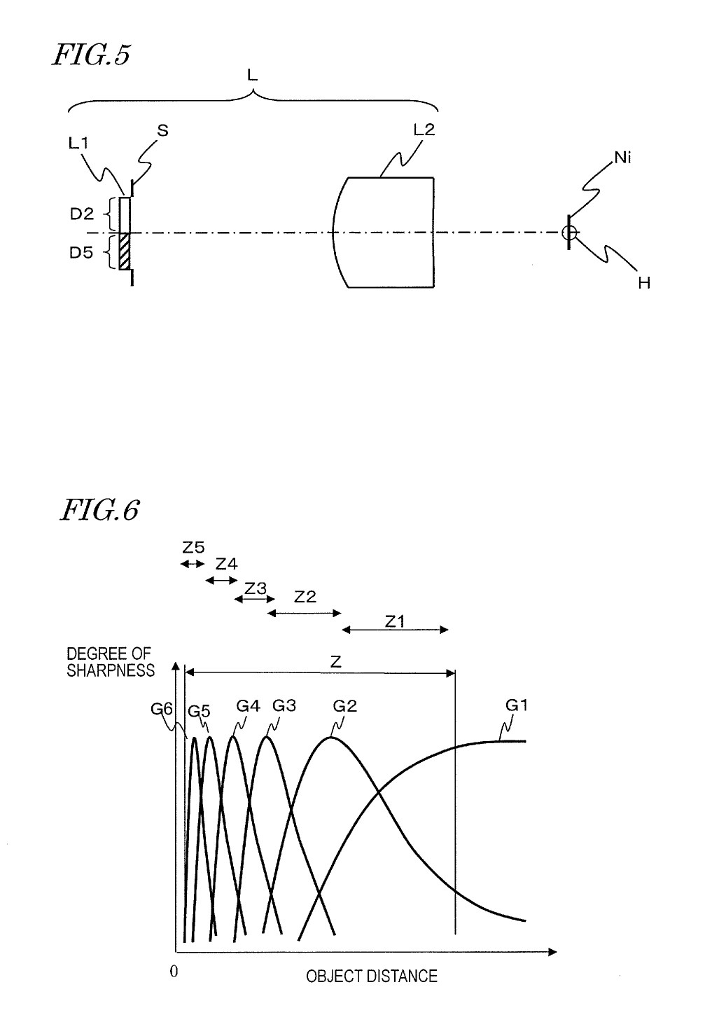

The relationship between the object distance and the degree of sharpness, shown in a graph, is as shown in FIG. 6. In the graph of FIG. 6, profiles G1, G2 . . . G6 denote the degrees of sharpness of predetermined regions of pixels produced only by the respective pixel groups P1, P2, P3, P4, P5 and P6. The degree of sharpness can be obtained based on the difference in brightness value between adjacent pixels in an image block of a predetermined size. The brightness distribution of an image block of a predetermined size can be obtained based on a Fourier-transformed frequency spectrum.

Where E denotes the degree of sharpness in a block of a predetermined size, it can be obtained based on the difference in brightness value between adjacent pixels by using Expression 1, for example.

$$E = {\sum }_{i} {\sum }_{j} \sqrt{{( Δ {x}_{i , j} )}^{2} + {( k Δ {y}_{i , j} )}^{2}} \qquad [ Expression 1 ]$$

In Expression 1, Δx_{i,j} is the difference value between the brightness value of a pixel at a certain coordinate point in an image block of a predetermined size and the brightness value of a pixel at the same position in an adjacent block, Δy_{i,j} is the difference value between the brightness value of a pixel at a coordinate point in an image block of a predetermined size and the brightness value of a pixel at the same position in an adjacent block, and k is a coefficient. It is preferred that Δy_{i,j} is multiplied by a predetermined coefficient.

Next, a method for obtaining the degree of sharpness E in a block of a predetermined size based on a Fourier-transformed frequency spectrum. Since the image is two-dimensional, a method for obtaining the degree of sharpness using a two-dimensional Fourier transform will be described. Herein, a case where the degree of sharpness for a predetermined block size is obtained by a two-dimensional Fourier transform will be described.

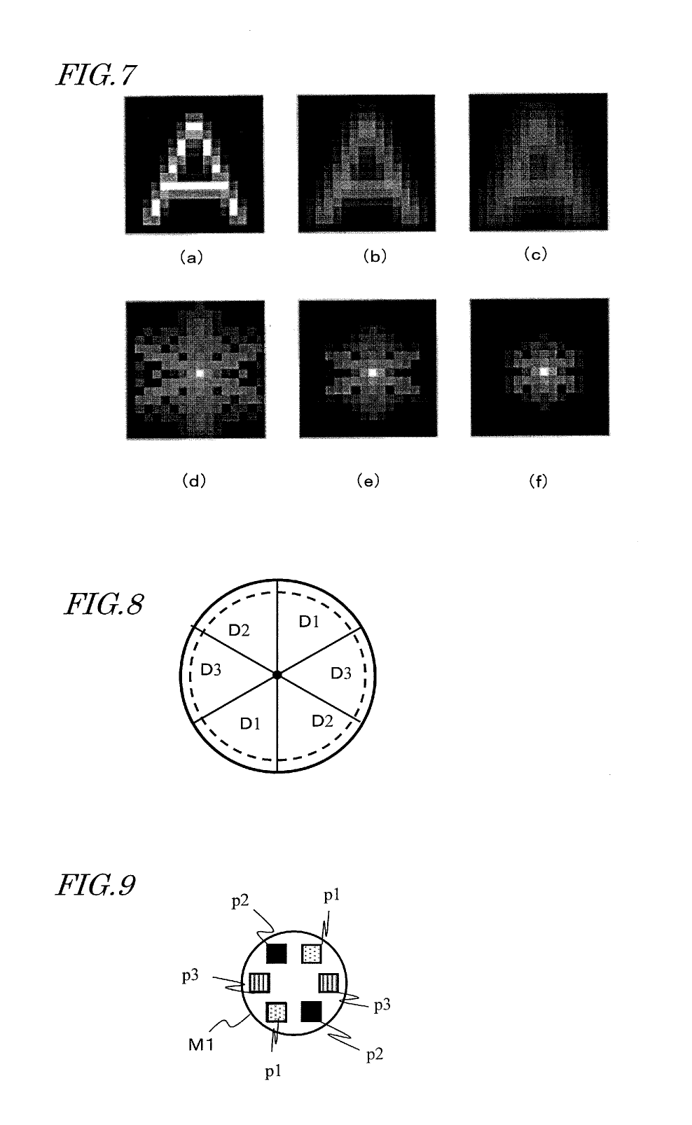

FIGS. 7(a) to 7(c) each show the brightness distribution of an image block having a size of 16×16. The degree of sharpness decreases in the order of FIGS. 7(a), 7(b) and 7(c). FIGS. 7(d) to 7(f) show frequency spectrums obtained by a two-dimensional Fourier transform on the image blocks of FIGS. 7(a) to 7(c). In FIGS. 7(d) to 7(f), for ease of understanding, the intensity of each frequency spectrum is shown after being logarithmically transformed, where it is brighter for a frequency spectrum of a higher intensity. In each frequency spectrum, the position of the highest brightness at the center is the DC component, and the frequency increases toward the peripheral portion. In FIGS. 7(d) to 7(f), it can be seen that more higher frequency spectrum values are missing for a lower degree of sharpness of the image. Therefore, in order to obtain the degree of sharpness from these frequency spectrums, it can be obtained by extracting the whole or a part of the frequency spectrum, for example.

Now, the range of Z in FIG. 6 represents an area over which at least one of the degrees of sharpness G1, G2, G3, G4, G5 and G6 is changing. In the range of Z, the object distance can be obtained by using such a relationship. For example, the object distance has a correlation with the ratio between the degrees of sharpness G1 and G2 in the range of Z, the ratio between the degrees of sharpness G2 and G3 in the range of Z2, the ratio between the degrees of sharpness G3 and G4 in the range of Z3, the ratio between the degrees of sharpness G4 and G5 in the range of Z4, and the ratio between the degrees of sharpness G5 and G6 in the range of Z5. Thus, while the object distance is within a certain range (z1 to z6), the value of the ratio between the degrees of sharpness of any two of six images formed by light beams incident on the six optical regions D1 to D6 has a correlation with the object distance. The correlations between these degrees of sharpness and the object distances are stored in advance in the storage section Me.

When the image pickup apparatus is used, of the data obtained as a result of a single iteration of image capture, the ratio between the degrees of sharpness of the images I1, I2, I3, I4, I5 and I6 produced for the respective pixel groups P1, P2, P3, P4, P5 and P6 is obtained for each arithmetic block. Then, the object distance can be obtained by using correlations stored in the storage section Me (the correlation between any two images and the ratio between the degrees of sharpness thereof). Specifically, for each arithmetic block, the ratio between degrees of sharpness of the correlation is compared with the value of the ratio between the degrees of sharpness of the images I1, I2, I3, I4, I5 and I6. Then, the object distance corresponding to the value at which they match is used as the distance to the object at the time of the image-capturing operation.

In order to uniquely obtain the object distance based on the ratios between the degrees of sharpness of the images I1, I2, I3, I4, I5 and I6, the ratios between the degrees of sharpness need to be all different from one another over a predetermined object distance range.

In FIG. 6, the configuration is such that the degree of sharpness is high for one of the optical systems in the range of Z, and the ratios between the degrees of sharpness all different from one another, thus making it possible to uniquely obtain the object distance. Since the ratio cannot be obtained if the value of the degree of sharpness is too low, it is preferred that the value of the degree of sharpness is greater than or equal to a certain value.

Note that the relationship between the object distance and the degree of sharpness is dictated by the radius of curvature of the surface of the optical regions D1, D2, D3, D4, D5 and D6, the spherical aberration characteristics, and the refractive index. That is, the optical regions D1, D2, D3, D4, D5 and D6 need to have such optical characteristics that the ratios between the degrees of sharpness of the images I1, I2, I3, I4, I5 and I6 are all different from one another over a predetermined distance range.

Note that in the present embodiment, the object distance may be obtained by using a value other than the degree of sharpness, e.g., the contrast, as long as it is a value calculated using the brightness (brightness information). The contrast can be obtained, for example, from the ratio between the maximum brightness value and the minimum brightness value within a predetermined arithmetic block. While the degree of sharpness is a difference between brightness values, the contrast is a ratio between brightness values. The contrast may be obtained from the ratio between a point of the maximum brightness value and another point of the minimum brightness value, or the contrast may be obtained from the ratio between the average value among some higher brightness values and the average value among some lower brightness values, for example. Also where the object distance is obtained using the contrast, as in a case where the degree of sharpness is used, correlations between object distances and contrasts ratio are stored in advance in the storage section Me. By obtaining the contrast ratio between the images I1, I2, I3, I4, I5 and I6 for each block, it is possible to obtained the object distance using the correlation.

Note that the present embodiment may employ either one of the method of obtaining the degree of sharpness from the difference between brightness values of adjacent pixels, and the method of obtaining the degree of sharpness through Fourier transform. Note however that since the brightness value is a relative value, the brightness value obtained by the former method and the brightness value obtained by the latter method are different values. Therefore, the method of obtaining the degree of sharpness for obtaining correlations (correlations stored in advance between object distances and degrees of sharpness) and the method of obtaining the degree of sharpness at the time of image capture need to be matched with each other.

In the present embodiment, the optical system of the image pickup apparatus may use an image-side telecentric optical system. Thus, even if the field angle changes, the main beam incident angle of the arrayed optical device K is a value close to 0 degree, and it is therefore possible to reduce the crosstalk between light beams arriving at respective pixel groups P1, P2, P3, P4, P5 and P6 over the entire image pickup area.

In the present embodiment, an image-side non-telecentric optical system may be used as the lens optical system L. In such a case, since the radii of curvature of six regions of the optical device L1 are different from one another, magnifications of the obtained images I1, I2, I3, I4, I5 and I6 are different from one another for each of the regions. Now, where the ratio between degrees of sharpness is calculated for each image region, predetermined regions to be referenced are shifted from one another outside the optical axis, thus failing to correctly obtain the ratio between degrees of sharpness. In such a case, correction is made so that the magnifications of the images I1, I2, I3, I4, I5 and I6 are generally equal to one another, and the ratio between degrees of sharpness over a predetermined region is obtained, thus making it possible to obtain the ratio correctly.

In Embodiment 1, the areas of the optical regions D1, D2, D3, D4, D5 and D6 (the areas as viewed from a direction along the optical axis) are made equal to one another (generally equal area). With such a configuration, the exposure time can be made equal for the pixel groups P1, P2, P3, P4, P5 and P6. Where the areas of the optical regions D1, D2, D3, D4, D5 and D6 are different from one another, it is preferred that the exposure time is varied among the pixel groups P1, P2, P3, P4, P5 and P6 or a brightness adjustment is performed after image capture.

As described above, according to the present embodiment, correlations between object distances and ratios between degrees of sharpness (or the contrasts) of images obtained from the six optical regions D1, D2, D3, D4, D5 and D6 of the optical device L1 are stored in advance, and the distance to an object can be obtained by the ratio between degrees of sharpness (or the contrasts) of the images I1, I2, I3, I4, I5 and I6 and the correlations. That is, by performing a single iteration of image capture, for example, using an image pickup apparatus of the present embodiment, it is possible to obtain brightness information with which the object distance can be measured. Then, the object distance can be calculated using the brightness information. As described above, in the present embodiment, since it is possible to obtain the distance to an object through (e.g., a single iteration of) image capture using a single image pickup optical system (the lens optical system L), it is not necessary to make uniform the characteristics or the positions of a plurality of image pickup optical systems as with an image pickup apparatus using a plurality of image pickup optical systems. Moreover, where a movie is captured using an image pickup apparatus of the present embodiment, it is possible to measure the accurate distance to an object even if the position of the object varies over the passage of time.

Note that with an arrangement such that the center points of the pixels are at the apices of a regular hexagon on the image pickup surface Ni, the number of kinds of optical characteristics of the optical regions D1, D2, D3, D4, D5 and D6 may be three instead of six. That is, as shown in FIG. 8, two of the divided six regions that are located in point symmetry with each other with respect to the optical axis may be provided with the same optical characteristics, thereby resulting in a configuration where there are three optical regions (D1, D2, D3) such that focal characteristics are made different from one another. Then, as shown in FIG. 9, an arrangement is used such that the center points of pixels are at the apices of a regular hexagon on the image pickup device N. Light beams having passed through the three optical regions D1, D2 and D3 are incident on the pixel groups P1, P2 and P3, respectively. Two pixels p1 included in the pixel group P1 are located in point symmetry with each other with respect to the central axis of the optical element M1. Similarly, each of two pixels p2 and two pixels p3 included in the pixel groups P2 and P3 are located in point symmetry with each other with respect to the central axis of the optical element M1. With such a configuration, no parallax occurs between images obtained in the pixel groups P1, P2 and P3, on which light beams having passed through the optical regions D1, D2 and D3, respectively, are incident. This allows for precise distance measurement.

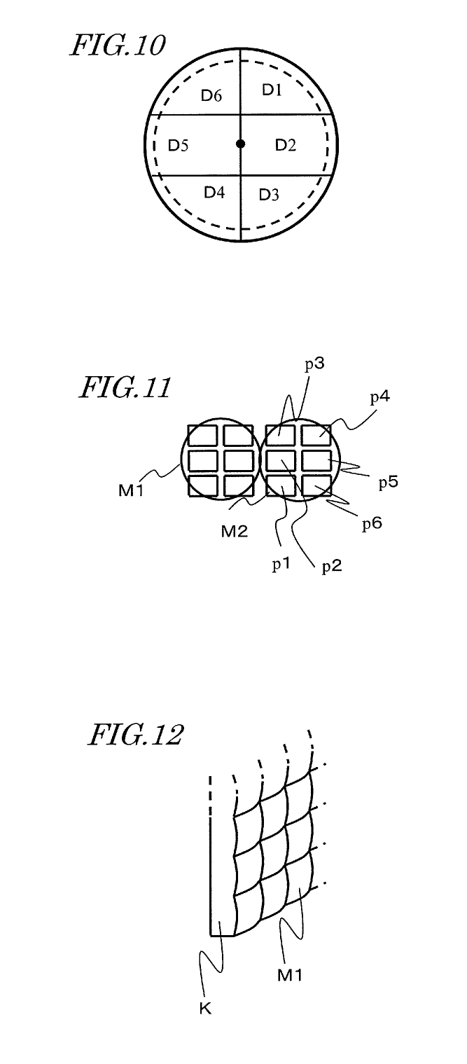

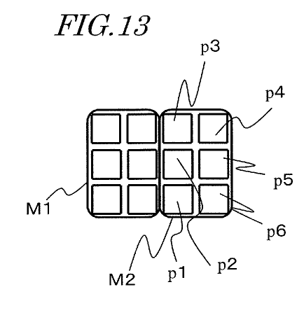

As shown in FIG. 10, the region may be divided in six by dividing it in two in the lateral direction on a plane including the optical axis therein and in three in the longitudinal direction, thereby forming regions (D1, D2, D3, D4, D5 and D6) having optical characteristics different from one another. Then, one may consider combining together a microlens array having a grid array of microlenses, and rectangular pixels as shown in FIG. 11. Similar advantageous effects are obtained also by arranging a microlens array including microlenses (the optical elements M1) each having a rectangular outer shape as shown in FIG. 12 so that six square pixels correspond to one microlens (the optical element M1) as shown in FIG. 13.

### Embodiment 2

Embodiment 2 is different from Embodiment 1 in that the region of the optical device L1 is divided in seven. In the present embodiment, similar contents to Embodiment 1 will not herein be described in detail.

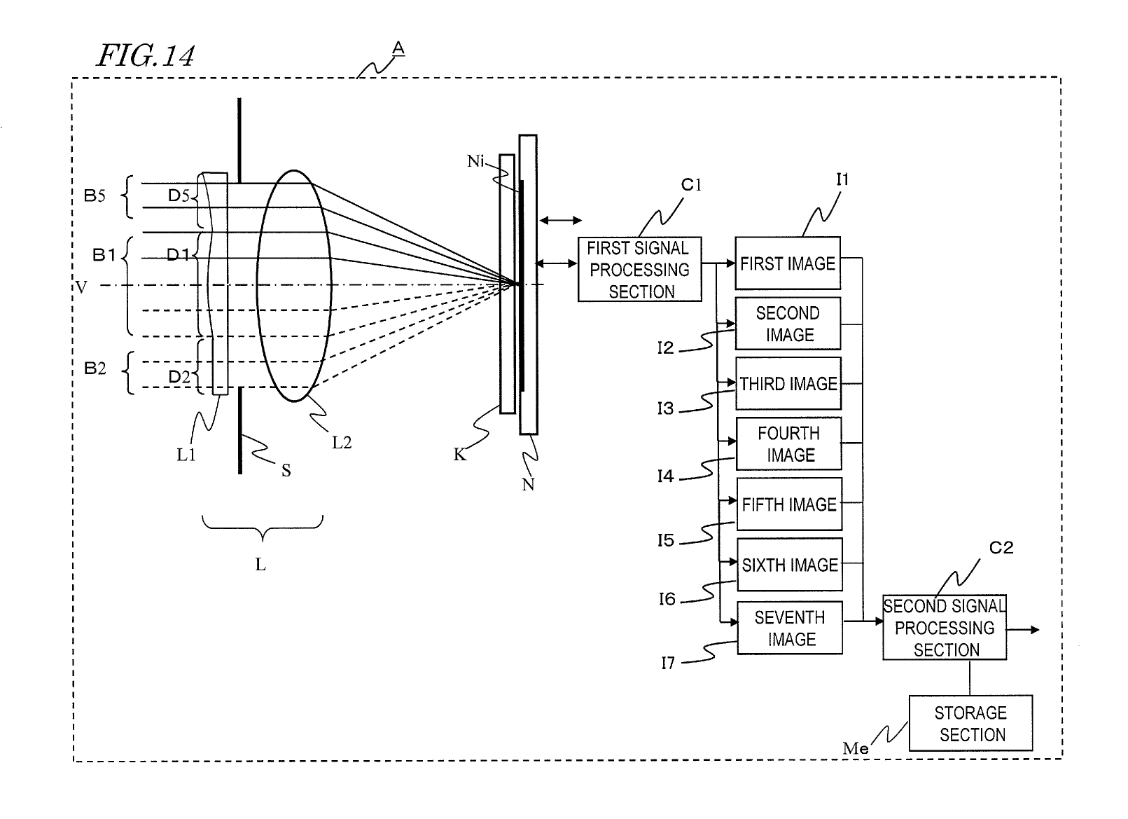

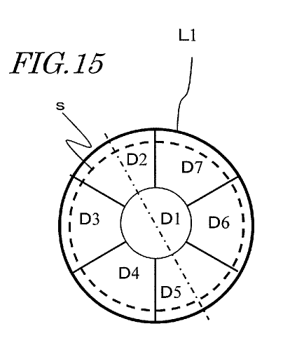

FIG. 14 is a schematic diagram showing Embodiment 2 of the image pickup apparatus A according to the present invention. In FIG. 14, like components to those Embodiment 1 are denoted by like reference numerals. The image pickup apparatus A of the present embodiment includes a lens optical system L whose optical axis is V, an arrayed optical device K arranged in the vicinity of the focal point of the lens optical system L, an image pickup device N, a first signal processing section C1, a second signal processing section C2, and a storage section Me. The lens optical system L has seven optical regions D1, D2, D3, D4, D5, D6 and D7 (FIG. 14 shows a cross section passing through D1, D2 and D5) having such optical characteristics that focal characteristics are made different from one another, and is composed of an optical device L1 on which light beams B1, B2, B3, B4, B5, B6 and B7 (FIG. 14 shows a cross section passing through B1, B2 and B5) from an object (not shown) are incident, a stop S on which light having passed through the optical device L1 is incident, and a lens L2 on which light having passed through the stop S is incident.

The stop S is installed in the vicinity of the lens optical system L, and has a single opening.

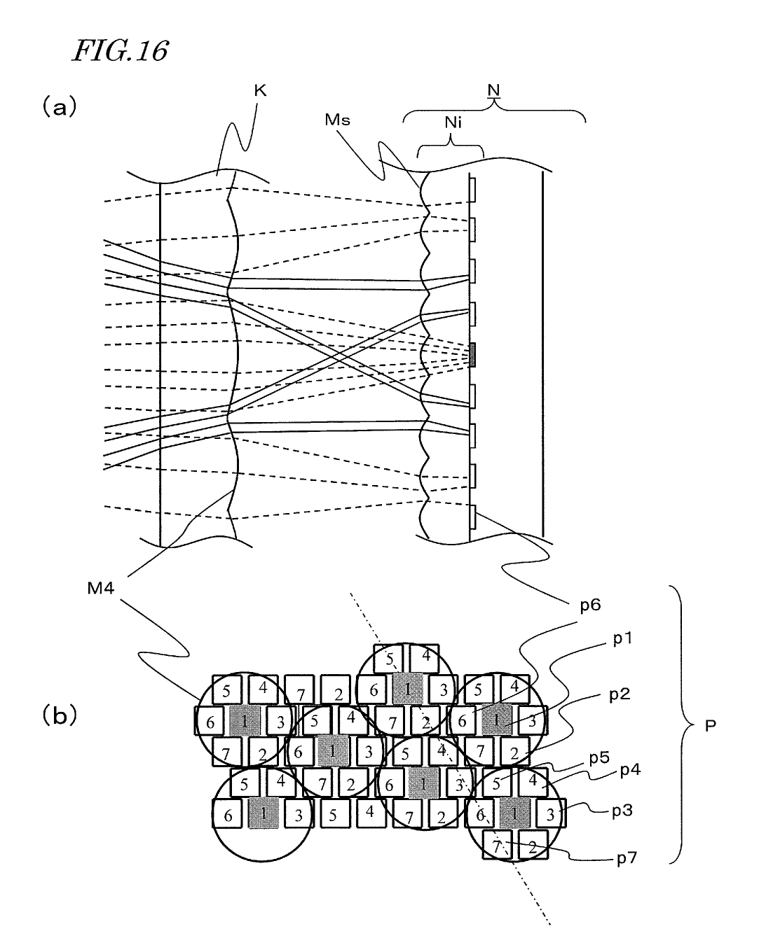

In the present embodiment, light beams having passed through the seven optical regions D1, D2, D3, D4, D5, D6 and D7 pass through the lens L2 and then are incident on the arrayed optical device K. The arrayed optical device K causes the light beams having passed through the seven optical regions D1, D2, D3, D4, D5, D6 and D7 to be incident on the pixel groups P1, P2, P3, P4, P5, P6 and P7 (shown in FIG. 16, etc.) of the image pickup device N, respectively. The first signal processing section C1 outputs images I1, I2, I3, I4, I5, I6 and I7 obtained from the pixel groups P1, P2, P3, P4, P5, P6 and P7, respectively. Since the optical characteristics of the seven optical regions D1, D2, D3, D4, D5, D6 and D7 are different from one another, the degrees of sharpness (values calculated by using the brightness) of the images I1, I2, I3, I4, I5, I6 and I7 are different from one another depending on the object distance. The storage section Me stores the correlation between the degree of sharpness and the object distance for each of the light beams having passed through the optical regions D1, D2, D3, D4, D5, D6 and D7. In the second signal processing section C2, it is possible to obtain the distance to the object based on the degrees of sharpness for the images I1, I2, I3, I4, I5, I6 and I7 and the correlations.

FIG. 15 is a front view of the optical device L1 as viewed from the object side. The optical region includes one central region D1 located at the optical axis of the lens optical system, and six surrounding regions D2, D3, D4, D5, D6 and D7 located around the central region D1.

While the optical region D1 has a different shape from the optical regions D2, D3, D4, D5, D6 and D7 in Embodiment 2, the optical regions D1, D2, D3, D4, D5, D6 and D7 have an equal area. With such a configuration, the exposure time can be made equal between the pixel groups P1, P2, P3, P4, P5, P6 and P7 on which light beams from the optical regions are incident. Note that where the optical regions have different areas, it is preferred that the exposure time is made different between pixels depending on their areas, or the brightness is adjusted in the image generation process.

The broken line s denotes the position of the stop S.

In the present embodiment, the configuration of the arrayed optical device K is similar to that of Embodiment 1, and the perspective view of the arrayed optical device K of the present embodiment is similar to that of FIG. 3.

FIG. 16(a) is a diagram showing, on an enlarged scale, the arrayed optical device K and the image pickup device N shown in FIG. 14, and FIG. 16(b) is a diagram showing the positional relationship between the arrayed optical device K and pixels on the image pickup device N.

The arrayed optical device K is arranged so that the surface thereof on which the optical elements M4 are formed is facing the image pickup surface Ni. On the image pickup surface Ni, a plurality of pixels P are arranged in n rows (n is an integer greater than or equal to 2), for example. As shown in FIG. 16(b), they are arranged while shifting the positions of the center points of the pixels in the row direction (lateral direction) from one row to another by half the arrangement pitch. A plurality of pixels P can each be classified as one of pixels p1, p2, p3, p4, p5, p6 and p7 belonging to one of the pixel groups P1, P2, P3, P4, P5, P6 and P7. The six pixels p2, p3, p4, p5, p6 and p7 included in the pixel groups P2, P3, P4, P5, P6 and P7, respectively, are arranged at the apices of a hexagon, with the pixel p1 included in the pixel group P1 being arranged at the center of the hexagon.

The arrayed optical device K is arranged in the vicinity of the focal point of the lens optical system L, and is arranged at a position away from the image pickup surface Ni by a predetermined distance. On the image pickup surface Ni, the microlenses Ms are provided so as to cover the surfaces of seven pixels p1, p2, p3, p4, p5, p6 and p7 included in the pixel groups P1, P2, P3, P4, P5, P6 and P7, respectively.

The arrayed optical device K is arranged so that the surface thereof on which the optical elements M4 are formed is facing the image pickup surface Ni. The arrayed optical device K is configured so that one optical element M4 corresponds to seven pixels p1, p2, p3, p4, p5, p6 and p7 included in the pixel groups P1, P2, P3, P4, P5, P6 and P7, respectively. The arrayed optical device is designed so that the majority of the light beams B1, B2, B3, B4, B5, B6 and B7 having passed through the optical regions D1, D2, D3, D4, D5, D6 and D7 on the optical device L1 arrives at the pixel groups P1, P2, P3, P4, P5, P6 and P7 on the image pickup surface Ni, respectively. Specifically, this configuration can be realized by appropriately setting parameters, such as the refractive index of the arrayed optical device K, the distance from the image pickup surface Ni, and the radius of curvature of the surface of the optical element M4.

Now, the first signal processing section C1 shown in FIG. 14 outputs the first image I1 formed only by the pixel group P1. Similarly, the images I2, I3, I4, I5, I6 and I7 formed only by the pixel groups P2, P3, P4, P5, P6 and P7, respectively, are output. The second signal processing section C2 performs a distance measurement calculation using the brightness information represented by differences in brightness value between adjacent pixels (the degree of sharpness) in the images I1, I2, I3, I4, I5, I6 and I7.

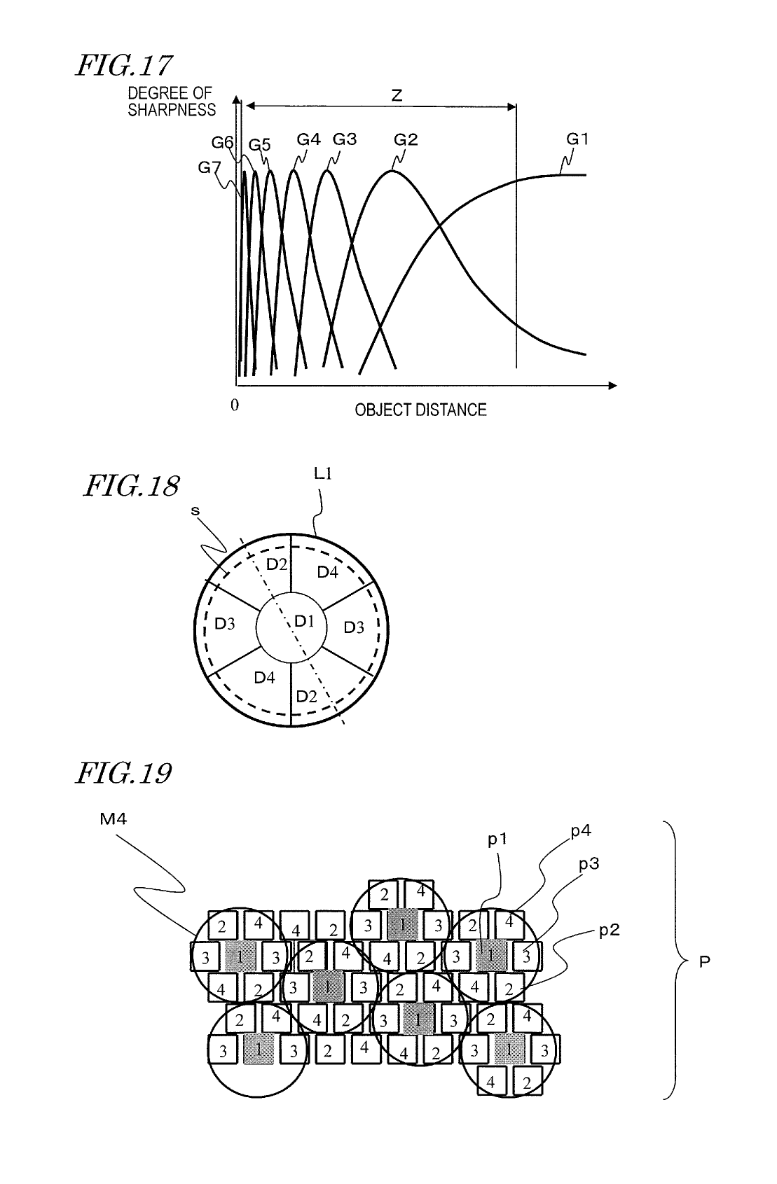

In Embodiment 2, the relationship between the object distance and the degree of sharpness is as shown in FIG. 17, and the object distance can be obtained in the range of Z.

As described above, the present embodiment is configured so that seven different images can be obtained simultaneously by seven regions having such optical characteristics that focal characteristics are made different from one another, and it is therefore possible to obtain the distance to an object through (e.g., a single iteration of) image capture using a single image pickup optical system. With this configuration, it is possible to expand the object distance range over which the distance can be measured, as compared with the embodiment shown in FIG. 6 where the region is divided into six regions.

Note that where the positions of the center points of the pixels in the row direction are arranged while being shifted from one row to another by half the arrangement pitch on the image pickup surface Ni, the number of kinds of optical characteristics of the optical regions D1, D2, D3, D4, D5, D6 and D7 may be four instead of seven. That is, as shown in FIG. 18, each two of the seven regions including one central region located at the optical axis of the lens optical system and six surrounding regions located around the central region that are located in point symmetry with each other with respect to the optical axis are given the same optical characteristics, resulting in four optical regions (D1, D2, D3 and D4) having such optical characteristics that focal characteristics are made different from one another. Then, as shown in FIG. 19, the pixels are arranged while shifting the positions of the center points of the pixels in the row direction from one row to another by half the arrangement pitch. Pixels included in the pixel group P1 on which light beams having passed through the optical regions D1 are incident are located at the central axis of the optical elements M4. Light beams having passed through the optical regions D2, D3 and D4 each including two regions located in point symmetry with each other with respect to the optical axis are incident on the pixel groups P2, P3 and P4, respectively. Two pixels p2 included in the pixel group P2 are located in point symmetry with each other with respect to the central axis of the optical element M4. Similarly, each of two pixels p3 and two pixels p4 included in the pixel groups P3 and P4 are located in point symmetry with each other with respect to the central axis of the optical element M4. With such a configuration, no parallax occurs between images obtained in the pixel groups P1, P2, P3 and P4, on which light beams having passed through the optical regions D1, D2, D3 and D4, respectively, are incident. This allows for precise distance measurement.

### Other Embodiments

Note that while Embodiments 1 and 2 are examples where curved surface configurations, etc., for making focal characteristics different from one another are arranged on the object-side surface of the optical device L1, such curved surface configurations, etc., may be arranged on the image-side surface of the optical device L1.

While the lens L2 has a single-lens configuration, it may be a lens configured with a plurality of groups of lenses or a plurality of lenses.

A plurality of optical regions may be formed on the optical surface of the lens L2 arranged in the vicinity of the stop.

While the optical device L1 is arranged on the object side with respect to the position of the stop, it may be arranged on the image side with respect to the position of the stop.

Embodiments 1 and 2 are directed to an image pickup apparatus including the first signal processing section C1, the second signal processing section C2, and the storage section Me (shown in FIG. 1, etc.). The image pickup apparatus of the present invention does not have to include the signal processing section and the storage section. In such a case, processes performed by the first signal processing section C1 and the second signal processing section C2 may be performed by using a PC, or the like, external to the image pickup apparatus. That is, the present invention may be implemented by a system including an image pickup apparatus, which includes the lens optical system L, the arrayed optical device K and the image pickup device N, and an external signal processing device. With the image pickup apparatus of this embodiment, it is possible to obtain brightness information with which the object distance can be measured by performing (e.g., a single iteration of) image capture using a single image pickup optical system. The object distance can be obtained through a process performed by an external signal processing section using the correlations between the brightness information and the degree of sharpness (or the contrast) stored in the external storage section.

Note that with the distance measurement method of the present invention, correlations between the degree of sharpness and the object distance do not always have to be used. For example, the object distance may be obtained by substituting the obtained degree of sharpness or contrast into an expression representing the relationship between the degree of sharpness or the contrast and the object distance.

It is preferred that the optical elements (microlenses) of the microlens array of Embodiments 1 and 2 are in a rotationally symmetric shape with respect to the optical axis within a range of a predetermined radius of each optical element. Hereinafter, description will be made in comparison with microlenses having a rotationally asymmetric shape with respect to the optical axis.

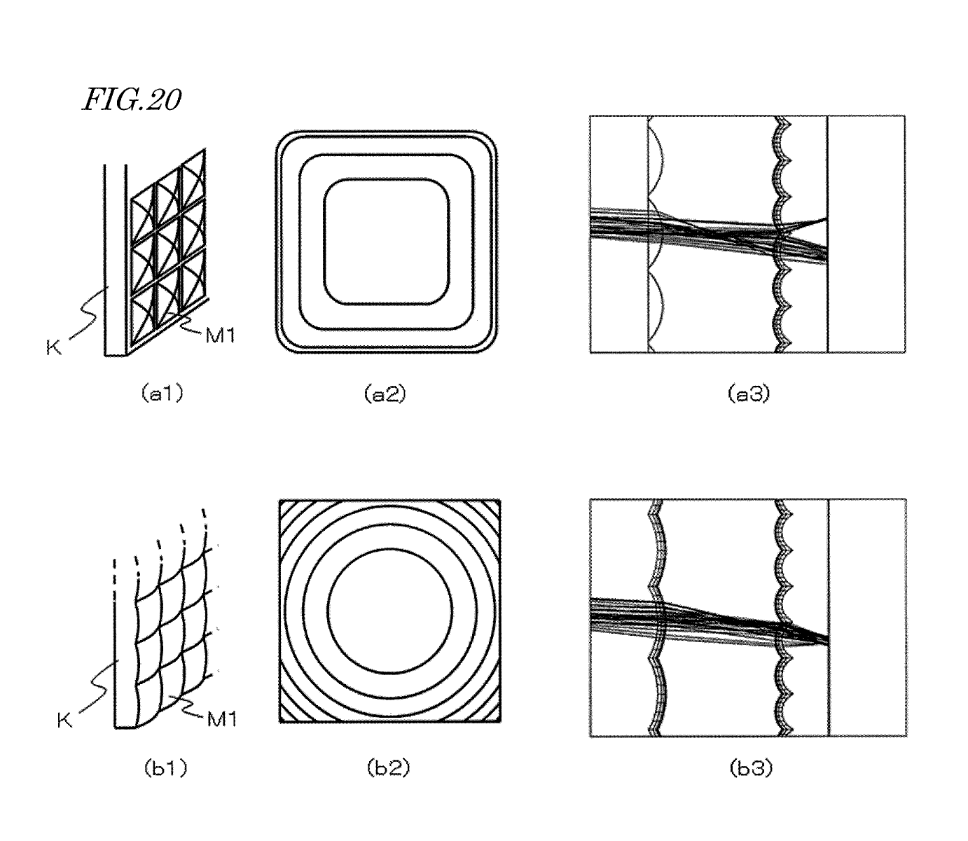

FIG. 20(a1) is a perspective view showing a microlens array having a rotationally asymmetric shape with respect to the optical axis. Such a microlens array is formed through patterning using a resist, which is obtained by forming a quadrangular prism-shaped resist on the array and performing a heat treatment, thereby rounding the corner portions of the resist. FIG. 20(a2) shows the contour lines of the microlens shown in FIG. 20(a1). With a microlens having a rotationally asymmetric shape, the radius of curvature in the longitudinal and lateral directions (directions parallel to the four sides of the bottom surface of the microlens) differs from that in the diagonal direction (the diagonal direction across the bottom surface of the microlens).

FIG. 20(a3) is a diagram showing the results of a light beam tracking simulation in a case where the microlens shown in FIGS. 20(a1) and 20(a2) is applied to the arrayed optical device of the present invention. FIG. 20(a3) shows only the light beams passing through one optical region, of all the light beams passing through the arrayed optical device K. Thus, with a microlens having a rotationally asymmetric shape, light leaks to adjacent pixels, causing crosstalk.

FIG. 20(b1) is a perspective view showing a microlens array having a rotationally symmetric shape with respect to the optical axis. A microlens having such a rotationally symmetric shape can be formed on a glass plate, or the like, through a thermal imprinting or UV imprint process.

FIG. 20(b2) shows the contour lines of the microlens having a rotationally symmetric shape. With a microlens having a rotationally symmetric shape, the radius of curvature in the longitudinal and lateral directions is equal to that in the diagonal direction.

FIG. 20(b3) is a diagram showing the results of a light beam tracking simulation in a case where the microlens shown in FIGS. 20(b1) and 20(b2) is applied to the arrayed optical device of the present invention. While FIG. 20(b3) shows only the light beams passing through one optical region, of all the light beams passing through the arrayed optical device K, it can be seen that there is no such crosstalk as that shown in FIG. 20(a3). Thus, by providing a microlens having a rotationally symmetric shape, it is possible to reduce the crosstalk, and thus to suppress the deterioration of precision in the distance measurement calculation.

### INDUSTRIAL APPLICABILITY

An image pickup apparatus according to the present invention is useful as an image pickup apparatus such as a digital still camera or a digital video camera. It is also applicable to a distance measurement apparatus for monitoring the surroundings of an automobile and a person in an automobile, or a distance measurement apparatus for a three-dimensional information input for a game device, a PC, a portable terminal, and the like.

### REFERENCE SIGNS LIST

A Image pickup apparatus
L Lens optical system
L1 Optical device
L2 Lens
D1, D2, D3, D4, D5, D6, D7 Optical region
S Stop
K Arrayed optical device
N Image pickup device
Ni Image pickup surface
Me Storage section
Ms Microlens on image pickup device
M1, M2, M3, M4 Microlens (optical element) of arrayed optical device
P1, P2, P3, P4, P5, P6, P7 Light-receiving device (pixel group) on image pickup device
p1, p2, p3, p4, p5, p6, p7 Pixel
C1, C2 First, second signal processing section

1. An image pickup apparatus comprising:
a lens optical system having a plurality of regions including six regions having such optical characteristics that focal characteristics are made different from one another;
an image pickup device having a plurality of pixels on which light beams having passed through the lens optical system are incident; and
an arrayed optical device arranged between the lens optical system and the image pickup device for making light beams having passed through the six regions incident respectively on different pixels on the image pickup device.

2. The image pickup apparatus of claim 1, wherein:
the plurality of pixels include a plurality of pixels belonging to first to sixth pixel groups; and
light beams having passed through the six regions are incident on the first to sixth pixel groups, respectively.

3. The image pickup apparatus of claim 2, further comprising a signal processing section,
wherein the signal processing section calculates a distance to an object using brightness information of a plurality of pixels obtained from a plurality of pixel groups of the first to sixth pixel groups.

4. The image pickup apparatus of claim 3, wherein:
where an object distance is within a certain range, a value of a ratio between degrees of sharpness of any two of six images formed by light beams having been incident on the six regions has a correlation with the object distance; and
the signal processing section calculates the distance to the object based on the correlation and the ratio between the degrees of sharpness of the any two images.

5. The image pickup apparatus of claim 3, wherein:
where an object distance is within a certain range, a value of a ratio between contrasts of any two of six images formed by light beams having been incident on the six regions has a correlation with the object distance; and
the signal processing section calculates the distance to the object based on the correlation and the ratio between the contrasts of the any two images.

6. The image pickup apparatus of claim 2, wherein center points of six pixels included respectively in the first to sixth pixel groups are located at apices of a regular hexagon.

7. The image pickup apparatus of claim 2, wherein:
the arrayed optical device is a microlens array in which optical elements, which are microlenses, are arranged in a hexagonal close-packed pattern; and
the arrangement is such that six pixels included respectively in the first to sixth pixel groups correspond to one optical element.

8. The image pickup apparatus of claim 7, wherein each microlens optical element has a rotationally symmetric shape within a range of a predetermined radius from an optical axis of the optical element.

9. The image pickup apparatus of claim 1, wherein the six regions are a plurality of regions arranged in point symmetry with each other with an optical axis of the lens optical system interposed therebetween.

10. The image pickup apparatus of claim 1, wherein the six regions have generally an equal area and different radii of curvature as viewed from a direction along an optical axis of the lens optical system.

11. The image pickup apparatus of claim 1, wherein:
the lens optical system further includes at least one region other than the six regions; and
the arrayed optical device makes light beams having passed through seven regions, including the six regions and the one region, incident on different pixels on the image pickup device.

12. The image pickup apparatus of claim 11, further comprising a signal processing section, wherein:
the plurality of pixels include a plurality of pixels belonging to a seventh pixel group;
a light beam having passed through the one region is incident on the seventh pixel group; and
the signal processing section calculates a distance to an object using brightness information of a plurality of images obtained from a plurality of pixel groups of the first to seventh pixel groups on which light beams having passed through the seven regions are incident.

13. The image pickup apparatus of claim 12, wherein:
where an object distance is within a certain range, a value of a ratio between degrees of sharpness of any two of seven images formed by light beams having been incident on the seven regions has a correlation with the object distance; and
the signal processing section calculates the distance to the object based on the correlation and the ratio between the degrees of sharpness of the any two images.

14. The image pickup apparatus of claim 12, wherein:
where an object distance is within a certain range, a value of a ratio between contrasts of any two of seven images formed by light beams having been incident on the seven regions has a correlation with the object distance; and
the signal processing section calculates the distance to the object based on the correlation and the ratio between the contrasts of the any two images.

15. The image pickup apparatus of claim 11, wherein:
a plurality of pixels of the image pickup device are arranged in n rows (n is an integer greater than or equal to 2); and
positions of center points of the plurality of pixels in a row direction are shifted from one row to another by half a pixel arrangement pitch.

16. The image pickup apparatus of claim 15, wherein the seven regions include one central region located at an optical axis of the lens optical system, and six surrounding regions located around the central region.

17. An image pickup apparatus comprising:
a lens optical system having a plurality of regions including three regions having such optical characteristics that focal characteristics are made different from one another;
an image pickup device having a plurality of pixels on which light beams having passed through the lens optical system are incident and of which center points of the pixels are located at apices of a regular hexagon; and
an arrayed optical device arranged between the lens optical system and the image pickup device for making light beams having passed through the three regions incident on different pixels on the image pickup device.

18. The image pickup apparatus of claim 17, wherein each of the three regions includes two regions arranged in point symmetry with an optical axis of the lens optical system interposed therebetween.

19. An image pickup apparatus comprising:
a lens optical system having a plurality of regions including four regions having such optical characteristics that focal characteristics are made different from one another;
an image pickup device including a plurality of pixels on which light beams having passed through the lens optical system are incident and which are arranged in n rows (n is an integer greater than or equal to 2); and
an arrayed optical device arranged between the lens optical system and the image pickup device for making light beams having passed through the four regions incident on different pixels on the image pickup device,
wherein positions of center points of the plurality of pixels in a row direction are shifted from one row to another by half a pixel arrangement pitch.

20. The image pickup apparatus of claim 19, wherein:
the four regions includes one central region located at an optical axis of the lens optical system, and three regions located around the central region; and
each of the three regions includes two regions arranged in point symmetry with an optical axis of the lens optical system interposed therebetween.

21. The image pickup apparatus of claim 1, wherein:
the lens optical system further comprises a stop; and
the plurality of regions are arranged in the vicinity of the stop.

22. (canceled)

23. The image pickup apparatus of claim 1, wherein the arrayed optical device is formed on the image pickup device.

24. The image pickup apparatus of claim 23, further comprising a microlens provided between the arrayed optical device and the image pickup device,
wherein the arrayed optical device is formed on the image pickup device with the microlens therebetween.

25.-28. (canceled)
